(19) United States
(12) Patent Application Publication
(10) Pub. No.: US 2018/0131725 A1
(43) Pub. Date: May 10, 2018

(54) METHOD AND APPARATUS FOR MOBILE TERMINAL MANAGEMENT SUPPORTING SECURITY POLICY

(71) Applicant: ELECTRONICS AND TELECOMMUNICATIONS RESEARCH INSTITUTE, Daejeon (KR)

(72) Inventors: Seung-Hyun KIM, Daejeon (KR); Seok Hyun KIM, Daejeon (KR); Soo Hyung KIM, Daejeon (KR); Youngsam KIM, Daejeon (KR); Jong-Hyouk NOH, Daejeon (KR); Sangrae CHO, Daejeon (KR); Young Seob CHO, Daejeon (KR); Jin-Man CHO, Daejeon (KR); Seyoung HUH, Daejeon (KR); Jung Yeon HWANG, Daejeon (KR); Seung Hun JIN, Daejeon (KR)

(73) Assignee: ELECTRONICS AND TELECOMMUNICATIONS RESEARCH INSTITUTE, Daejeon (KR)

(21) Appl. No.: 15/642,450

(22) Filed: Jul. 6, 2017

(30) Foreign Application Priority Data
Nov. 10, 2016 (KR) 10-2016-0149840

(51) Int. Cl. H04L 29/06; G06F 9/445

(52) U.S. Cl. CPC H04L 63/20; G06F 8/65; H04L 63/10

(57) ABSTRACT

Disclosed is a method and apparatus for mobile terminal management supporting security policy. An exemplary embodiment of the present invention provides a terminal management method for installing a mobile device management (MDM) function in which a server supports a security policy for a binary mobile application, including: adding, by the server, an MDM interlocking code for each class-method unit of an original application of the binary mobile application; modifying, by the server, the original application into a modification application; and generating and transmitting, by the server, an MDM policy including at least one MDM function to be applied to the modification application to a mobile terminal.

### CROSS-REFERENCE TO RELATED APPLICATION

This application claims priority to and the benefit of Korean Patent Application No. 10-2016-0149840 filed in the Korean Intellectual Property Office on Nov. 10, 2016, the entire contents of which are incorporated herein by reference.

### BACKGROUND OF THE INVENTION

### (a) Field of the Invention

The present invention relates to a terminal management method and apparatus, and more particularly, to a terminal management method and apparatus that supports a security policy.

### (b) Description of the Related Art

Mobile device management (MDM) technology, which is for enhancing security of a mobile terminal, is mainly used to realize a company's bring your own device (BYOD) strategy. Although a user's mobile terminal is normally used for personal purposes, when the mobile terminal is utilized for business purposes, the settings of the mobile terminal may be changed to satisfy a security level of a corresponding company. Recently, the MDM technology has been developed as a mobile application management (MAM) technology that applies functions operating at a mobile terminal level to mobile applications.

A scheme of applying the MDM function to the mobile application may be mainly classified into source modification and binary modification.

In a case of the source modification, by securing a source code for the mobile application, a code or library for using the MDM function is added to a source code. Then, when a binary application is generated by compiling the source code, the binary application can use the MDM function. In the binary modification, the MDM function may be added by directly manipulating the binary application. Specifically, a binary code (e.g., assembly code) is extracted from the binary application, and the binary code or library for using the MDM function is added to the extracted binary code. Subsequently, when the binary code is inserted into the binary application, the binary application can use the MDM function.

The source modification and binary modification for applying the MDM function have technical limitations. The source modification scheme must secure the source code of the mobile application, and developers must write an additional MDM function based on the source code. However, in general, it is not easy to manage the source code for applying the MDM function and recruit developers. Unlike the source modification, the binary modification has attracted much attention in recent years because it does not require the securing of the source code and the direct code addition by the developer. However, it is difficult to actually develop a complete solution because it is difficult to extract and insert the binary code.

In addition, the binary modification scheme has the following three technical limitations.

First, the MDM function to be applied to the mobile application must be predefined. There must be a policy that specifies how the MDM function should be applied, so that the mobile application can be modified in the binary modification. That is, the MDM policy can be established and the binary modification can be performed only when the detailed configuration and operation of the mobile application are known in advance.

Second, it is difficult to grasp the configuration and operation for applying the MDM function to the mobile application. It is necessary to add a specific MDM function to a specific location of the mobile application, but the typical mobile application is obfuscated with the binary code for security. Accordingly, it is difficult to grasp a class name, a function name, and a variable name because they are changed to arbitrary characters, and the driving flow of the mobile application is also variously changed.

Third, it is difficult to change the MDM function applied to the mobile application. When the application policy for the MDM function is changed, the mobile application must be modified according to the changed policy. Whenever an existing MDM function is changed, a new MDM function is added, or a location to be applied to the mobile application is changed, it is necessary to modify the mobile application.

Conventional arts related to the MDM policy merely disclose general contents of receiving and applying the MDM policy in a specific situation, and conventional arts of modifying the binary application to apply the MDM policy also have the existing problems of the MDM function as described above.

### SUMMARY OF THE INVENTION

The present invention has been made in an effort to provide a terminal management method and apparatus that supports an MDM security policy that may be flexible and convenient by separating and processing MDM policy and binary modification.

Technical objects of the present invention are not limited to the technical objects described above, and other technical objects that are not mentioned may be clearly understood by a person of ordinary skill in the art from the following description.

An exemplary embodiment of the present invention provides a terminal management method for installing a mobile device management (MDM) function in which a server supports a security policy for a binary mobile application, including: adding, by the server, an MDM interlocking code for each class-method unit of an original application of the binary mobile application; modifying, by the server, the original application into a modification application; and generating and transmitting, by the server, an MDM policy including at least one MDM function to be applied to the modification application to a mobile terminal, wherein the MDM interlocking code may check the MDM policy, and calls an arbitrary MDM function.

The modifying may include: decompiling the original application to extract class files; generating a tag with a class name-method name at a beginning portion of a method of each class; and adding the MDM interlocking code together with the generated tag to the beginning portion of the method.

The modifying may include recompiling the original application to generate the modification application when it is completed to add the tag and the MDM interlocking code for each of the class files of the original application.

The arbitrary MDM function of the MDM policy may be performed while the modification application operates in a mobile terminal, and the MDM policy is checked according to the MDM interlocking code.

The terminal management method may further include performing, by the server, policy management of adding, modifying, or deleting the MDM function to, at, or from a predetermined location of each class-method unit of the binary mobile application according to data inputted through a management user interface (UI).

The performing of the policy management may include: outputting a history of calling the class-method unit including execution details of the method of the class and a currently executing location when the binary mobile application is executed; and performing policy management of adding, modifying, or deleting the MDM function to, at, or from a predetermined location of the outputted history calling class-method unit.

Another embodiment of the present invention provides a terminal management method for a mobile terminal that executes a binary mobile application provided from a server, including: executing, by the mobile terminal, the binary mobile application, an MDM interlocking code being added for each class-method unit of the binary mobile application; checking an MDM policy related to the MDM interlocking code when the MDM interlocking code is identified in the executed binary mobile application; and performing an arbitrary MDM function of the MDM policy related to the MDM interlocking code.

The MDM interlocking code may check the MDM policy, and calls the arbitrary MDM function.

The checking may include checking the MDM policy related to the MDM interlocking code of the MDM policies when MDM policies including at least one MDM function to be applied to the modification application are provided, stored, and managed from the server.

The MDM policy may be represented in a form including an MDM class name, an MDM method name, and a parameter. The performing of the MDM function may include calling an MDM class and an MDM method of the MDM policy related to the MDM interlocking code through a JAVA reflection method to perform an MDM function.

The MDM policy may include a tag with a class name-method name, and the MDM interlocking code may be added to a beginning portion of a method of each class together with the tag with the class name-method name.

Yet another embodiment of the present invention provides a server provided with an MDM function supporting a security policy for a binary mobile application, including: an input/output portion; and a processor that is connected to the input/output portion and performs installing of the MDM function, wherein the processor may include an app modification processor configured to add an MDM interlocking code for each class-method unit of an original application of the binary mobile application and to modify the original application into a modification application and an MDM policy processor configured to generate an MDM policy including at least one MDM function to be applied to the modification application to transmit it to a mobile terminal through the input/output portion, wherein the MDM interlocking code may check the MDM policy, and calls the arbitrary MDM function.

The app modification processor of the processor may include: a decompile processing module configured to decompile the original application to extract class files; an MDM function adding module configured to generate a tag with a class name-method name at a beginning portion of a method of each class and to add the MDM interlocking code together with the generated tag to the beginning portion of the method; and a recompile processing module configured to recompile the original application to generate the modification application when it is completed to add the tag and the MDM interlocking code for each of the class files of the original application.

The input/output portion may include a management UI, and the MDM policy processor of the processor may include a policy management module configured to perform policy management of adding, modifying, or deleting the MDM function to, at, or from a predetermined location of each class-method unit of the binary mobile application according to data inputted through the management UI, and a policy transmitting module configured to transmit the MDM policy including the MDM function to the mobile terminal through the input/output portion.

Another embodiment of the present invention provides a mobile terminal that executes a binary mobile application provided from a server, including: an input/output portion; and a processor that is connected to the input/output portion and executes the binary mobile application, wherein the processor may include: an MDM processor configured to receive MDM policies including at least one MDM function to be applied to the modification application through the input/output portion from the server to store and manage it; and a modification app processor configured to execute the binary mobile application, an MDM interlocking code being added for each class-method unit of the binary mobile application and to load the MDM policy related to the MDM interlocking code from the MDM processor to perform the MDM function, wherein the MDM interlocking code may check the MDM policy, and calls the arbitrary MDM function.

The modification app processor of the processor may include: a code executing module configured to execute the binary mobile application; a policy checking module configured to check whether the MDM policy related to the MDM interlocking code is present in the MDM processor when the MDM interlocking code is identified in the executed binary mobile application; and a policy applying module configured to execute the arbitrary MDM function of the MDM policy related to the MDM interlocking code.

The MDM processor of the processor may include a policy database configured to store the MDM policies provided from the server, and an MDM function processing module configured to perform the MDM function requested by the modification app processor.

The MDM policy may be represented in a form including an MDM class name, an MDM method name, and a parameter. The policy applying module may be configured to call an MDM class and an MDM method of the MDM policy related to the MDM interlocking code through a JAVA reflection method to perform an MDM function.

The MDM policy may include a tag with a class name-method name, and the MDM interlocking code may be added to a beginning portion of a method of each class together with the tag with the class name-method name.

### BRIEF DESCRIPTION OF THE DRAWINGS

FIG. 1 illustrates a schematic view of server and terminal structures for terminal management according to an exemplary embodiment of the present invention.

FIG. 2 illustrates a flowchart of an application modification process of a terminal management method according to an exemplary embodiment of the present invention.

FIG. 3 illustrates a flowchart of a modification mobile application driving process of a terminal management method according to an exemplary embodiment of the present invention.

FIG. 4 illustrates a schematic view of a method driving example according to an exemplary embodiment of the present invention.

FIG. 5 to FIG. 8 illustrate schematic views of an operation for adding an MDM policy according to an exemplary embodiment of the present invention.

FIG. 9 illustrates a schematic view of an MDM server according to another exemplary embodiment of the present invention.

FIG. 10 illustrates a schematic view of a mobile terminal according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, throughout the specification, unless explicitly described to the contrary, the word “comprise” and variations such as “comprises” or “comprising” will be understood to imply the inclusion of stated elements but not the exclusion of any other elements.

Terms such as first, second, A, B, (a), (b), and the like will be used to describe components according to an exemplary embodiment of the present invention. These terms are only used in order to distinguish any component from other components, and a feature, a sequence, an order, or the like of the corresponding component is not limited by these terms.

Hereinafter, a terminal management method and apparatus according to an exemplary embodiment of the present invention will be described.

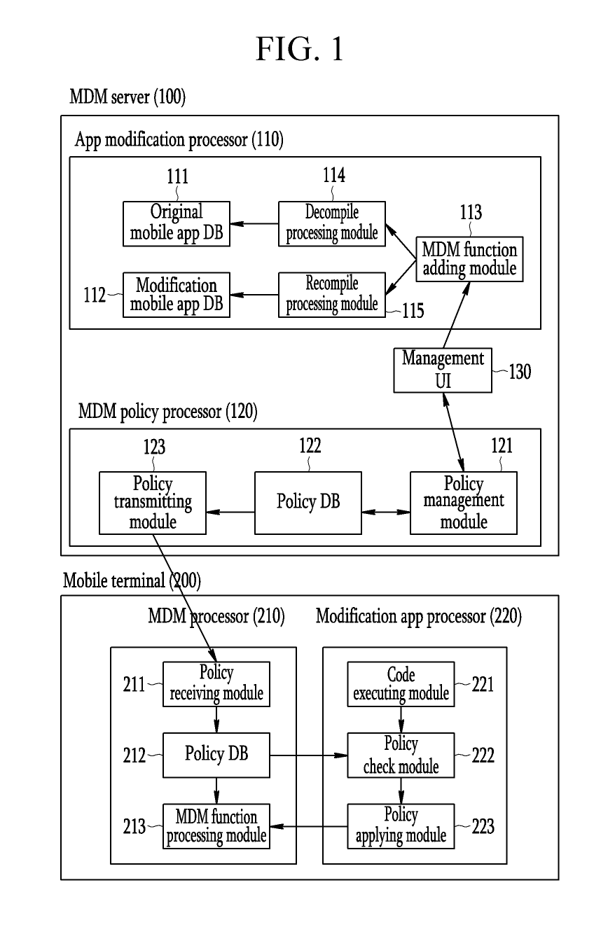

FIG. 1 illustrates a schematic view of server and terminal structures for terminal management according to an exemplary embodiment of the present invention.

For convenience of description, the word “application” will now be abbreviated as “app”.

As shown in FIG. 1, for a terminal management scheme according to an exemplary embodiment of the present invention, an MDM server 100 communicates with a mobile terminal 200 to incorporate an MDM function in a mobile app installed in the mobile terminal 200.

For this purpose, the MDM server 100 includes an app modification processor 110 and an MDM policy processor 120, and the app modification processor 110 and the MDM policy processor 120 are connected to each other through a management user Interface (UI) 130.

The app modification processor 110 is configured to modify an original mobile app into a modification mobile app. For this purpose, the app modification processor 110 includes an original mobile app database (DB) 111, a modification mobile app DB 112, an MDM function adding module 113, a decompile processing module 114, and a recompile processing module 115.

The original mobile app DB 111 stores the original mobile app (or referred to as an original app), and the modification mobile app DB 112 stores an app to which the MDM function is applied, that is, the modification mobile app (or referred to as a modification app).

The decompile processing module 114 extracts a binary code from the original mobile app stored in the original mobile app DB 111. The MDM function adding module 113 adds a code for extracting the MDM function to the binary code of the original mobile app transmitted from the decompile processing module 114.

The recompile processing module 115 generates an app by recombining the changed binary code transmitted from the MDM function adding module 113. The app generated by the binary code recombined by the recompile processing module 115 may be referred to as the modification mobile app, and the modification mobile app is stored and managed in the modification mobile app DB 112.

The MDM policy processor 120 manages an MDM policy and transmits it to a mobile terminal. For this purpose, the MDM policy processor 120 includes a policy management module 121, a policy DB 122, and a policy transmitting module 123.

The policy management module 121 generates, modifies, and deletes the MDM policy. The generating, modifying, and deleting of the MDM policy may be performed according to data inputted by the administrator through the management UI 130.

The policy DB 122 stores the MDM policy transmitted from the policy management module 121. The policy transmitting module 123 transmits the MDM policy to the mobile terminal 200.

For the MDM server 100, the administrator may call the MDM function adding module 113 for adding an MDM function of a specific original mobile app or may call the policy management module 121 for managing the MDM policy, through the management UI 130.

The mobile terminal 200 includes an MDM processor 210 and a modification app processor 220.

The MDM processor 210 receives and processes the MDM policy provided from the MDM server 100, and performs the MDM function. For this purpose, the MDM processor 210 includes a policy receiving module 211, a policy DB 212, and an MDM function processing module 213.

The policy receiving module 211 receives the MDM policy transmitted from the MDM server 100. The policy receiving module 211 stores the received MDM policy in the policy DB 222 to be managed.

The MDM function processing module 213 performs the MDM function requested by the modification app processor 220.

The MDM processor 210 may be realized as a daemon form.

The modification app processor 220 operates according to the modification mobile app provided from the MDM server 100, and performs an MDM function according to the MDM policy based on a code for calling the MDM function while performing the same operation as the original mobile app. For this purpose, the modification app processor 220 includes a code executing module 221, a policy check module 222, and a policy applying module 223.

The code executing module 221 executes a code of the modification mobile app. The modification mobile app includes a code of the original mobile app and a code for calling the MDM function added by the MDM server 100, and when the code of the modification mobile app is executed, an operation corresponding to the original mobile app is performed.

The policy check module 222 checks an MDM policy applied to an app in the code for calling the MDM function among the codes of the modification mobile app executed in the code executing module 221. Specifically, the policy check module 222 checks the MDM policy applied to the app from the policy DB 212 of the MDM processor 210 in the code for calling the MDM function.

The policy applying module 223 performs a specific MDM function according to the MDM policy checked by the policy check module 222. For this, when the policy applying module 223 requests the MDM function processing module 213 of the MDM processor 210 to perform the MDM function, the MDM function processing module 213 performs the MDM function.

First, for managing a terminal according to an exemplary embodiment of the present invention, an application modification process performed in the MDM server will be described.

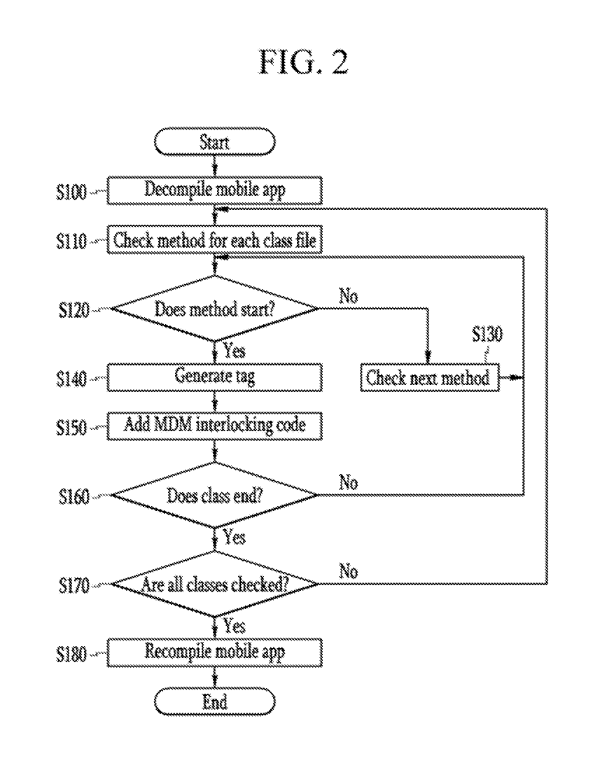

FIG. 2 illustrates a flowchart of an application modification process of a terminal management method according to an exemplary embodiment of the present invention.

The MDM server 100 performs application modification for an original mobile application to generate a modification mobile app. For this purpose, as shown in FIG. 2, the app modification processor 110 of the MDM server 100 decompiles an arbitrary original mobile app (S100). The app modification processor 110 decompiles the original mobile app while being driven depending on a request of the administrator inputted through the management UI 130. By decompiling the original mobile app, class files configuring the original mobile app are extracted.

The app modification processor 110 checks each class file extracted from the original mobile app to search for a method included in each class (S110). When the method is not found, the class file is checked until the method is found (S120 and S130). When a beginning portion of the method is found in the class file, a tag is generated, wherein the generated tag is a tag whose name is “class name-method” (S140). For example, when a class name is “kr.re.etri.sample.MainActivity” and a method is “onCreate( )”, a tag is “kr.re.etri.sample.MainActivity-onCreate ( )”.

In addition, an MDM interlocking code calling the MDM function together with the generated tag is added to the beginning portion of the method (S150). The MDM interlocking code may be represented as Code 1 below.

[Code 1]

const-string v0 ‘kr.re.etri.sample.MainActivity-onCreate( )’

| | |
|---|---|
| invoke-static | {v0}, |

Lkr/re/etri/reflectiontest/MainActivity;−>runMDM(Ljava/lang/String;)V′

Herein,

Lkdre/etri/reflectiontest/MainActivity;->runMDM(Ljava/lang/String;)V′ represents the MDM interlocking code.

Until the class file is completely read, a modification process of searching for the method and adding the MDM interlocking code to each method is repeated (S160).

When the process of adding the MDM interlocking code is completed in one class file as described above, the process of adding the MDM interlocking code is performed in a next class file (S170).

When the process of adding the MDM interlocking code is completed in all the class files, a recompiling process is performed to generate a modification mobile app (S180). When the process of generating the modification mobile app is completed normally, the app modification process is terminated.

The modification mobile app generated through the processes described above may be stored and managed in the modification mobile app DB 112 of the MDM server 100, and may be provided to the mobile terminal 200 according to a request of the mobile terminal 200.

Now, in a mobile terminal including the modification mobile app including the MDM function according to the adding of the MDM interlocking code described above, an operating process of the modification mobile app will be described.

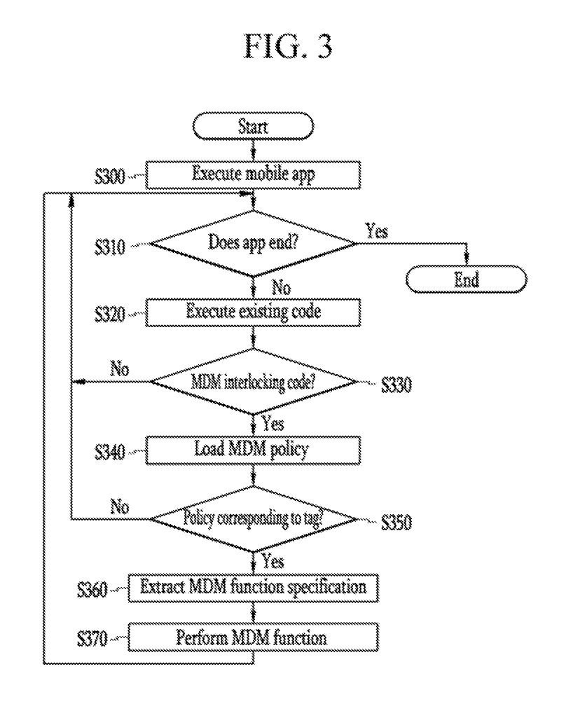

FIG. 3 illustrates a flowchart of a modification mobile application driving process of a terminal management method according to an exemplary embodiment of the present invention.

The modification mobile app including the MDM function according to the exemplary embodiment of the present invention is driven according to the MDM policy.

Referring to FIG. 3, when an app is started in the mobile terminal 200, the app executes a binary code thereof and provides a service. The binary code is executed until the app is terminated, and a flow thereof ends when the app is terminated (S300 and S310). Specifically, the modification app processor 220 of the mobile terminal 200 performs the same function as the original mobile app while executing the existing code (S320). Until the MDM interlocking code appears, the existing code is continuously executed.

While the existing code is executed, when the MDM interlocking code appears, a tag with a name of “class-method” of a location thereof is extracted (S330 and S340). The MDM interlocking code appears at the location in which the method of each class starts.

Subsequently, the MDM policy corresponding to the extracted “class-method” is searched. Specifically, the modification app processor 220 searches for the policy DB 212 of the MDM processor 210 to determine whether the MDM policy corresponding to the “class-method” of the extracted tag exists (S350).

When there is no MDM policy corresponding to the “class-method” of the tag, the MDM policy corresponding to the “class-method” of the tag again executes the existing code (S310), and when the MDM policy corresponding to the “class-method” of the tag exists, an MDM function specification requested in the MDM policy is extracted (S360) and a corresponding MDM function is performed (S370).

The MDM policy may be represented as a “tag, MDM class name, MDM method name, parameter” form. For example, the MDM policy may be represented as Code 2 below.

[Code 2]

kr.re.etri.sample.MainActivity, onCreate( ) , kr.re.etri.MDM,
init(Ljava/lang/String;), http://etri.re.kr

Herein, the “kr.re.etri.sample.MainActivity, onCreate( )” corresponds to the tag with the name of “class-method”, the “kr.re.etri.MDM” corresponds to the MDM class name, the “init(Ljava/lang/String;)” corresponds to the MDM method name, and the “http://etri.re.kr” corresponds to the parameter.

According to the MDM policy, when the modification mobile app executes the “onCreate( )” method of the “kr.re.etri.sample.MainActivity” class, the MDM function is performed. That is, the “init( )” method of the “kr.re.etri.MDM” MDM class is executed by using the “http://etri.re.kr” character string as the parameter. The “MDM class name, MDM method name, and parameter” corresponds to the MDM function specification.

The modification app processor 220 performs the MDM function according to the MDM function specification extracted from the MDM policy (S370).

More specifically, in the process of performing the MDM function, the policy check module 222 of the modification app processor 220 extracts the MDM method of the MDM class shown in the MDM policy such as [Code 2]. The policy applying module 223 executes the extracted MDM method, and specifically, it performs the MDM function by calling the MDM class and method through the JAVA reflection method.

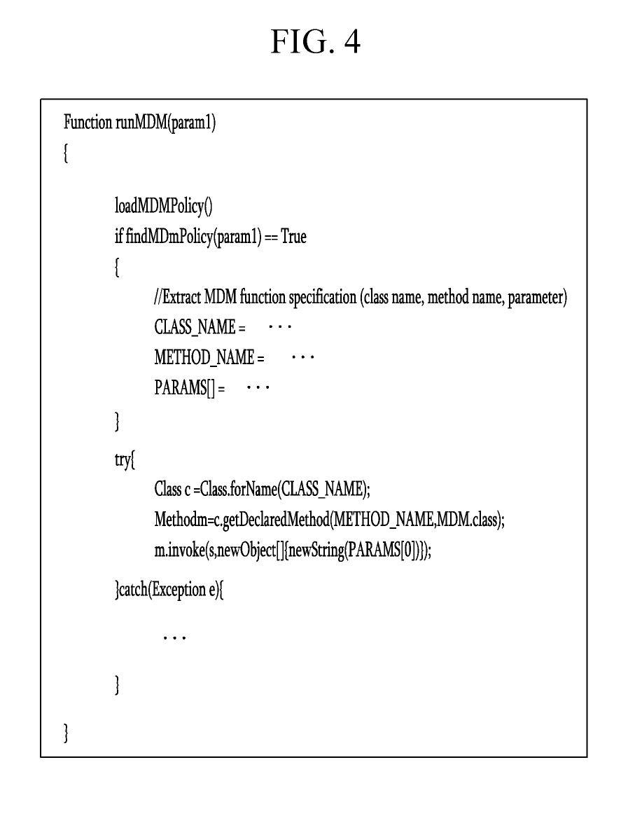

The operation of executing the MDM method is called in a form such as the runMDM( ) method of [Code 1]. An example of driving the runMDM( ) method is shown in FIG. 4. FIG. 4 illustrates a schematic view of a method driving example according to an exemplary embodiment of the present invention. As such, the MDM policy is searched and loaded, then an arbitrary MDM function is called through the java reflection method.

According to the exemplary embodiment of the present invention, by adding a general-purpose code, which may check the MDM policy per each class-method and perform an arbitrary MDM function, to the mobile app, the MDM policy provided in the MDM server may be performed by executing the general-purpose code in the mobile terminal and the arbitrary MDM function associated with the MDM policy.

Hereinafter, a process of adding the MDM policy in the MDM server will be described.

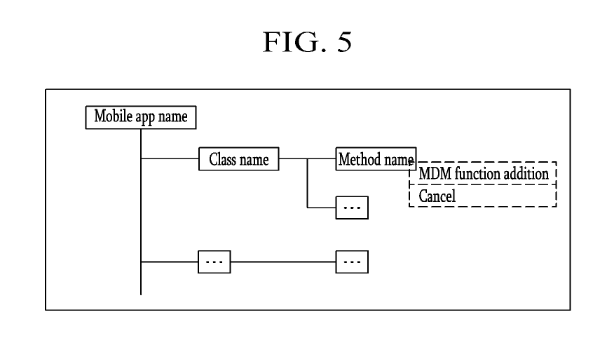

FIG. 5 to FIG. 8 illustrate schematic views of an operation for adding an MDM policy according to an exemplary embodiment of the present invention. Specifically, an example for explaining a process in which the administrator adds a policy to a specific location of the mobile app through the management UI in the MDM server so that the MDM function is performed, is illustrated. The process may be performed through the policy management module 121 of the MDM policy processor 120.

The administrator may view a list of the modification mobile apps with the MDM function through the management UI, check the MDM policies applied to the modification mobile apps, and add the MDM function thereto. When the arbitrary mobile app is selected in the modification mobile app, configuration details thereof and the MDM policy applied thereto may be identified. Specifically, the management UI of the MDM server may output the list of the modification mobile apps. When one mobile app's name is selected from the list of the modification mobile apps, as shown in FIG. 5, class names corresponding to the selected mobile app are outputted, and when a class is selected, a method name included in the class is outputted. When the method name is selected, as in the box indicated by the dotted line in FIG. 5, one of “MDM function addition” and “cancel” buttons may be selected. When the “MDM function addition” button is selected, the MDM function may be immediately added to a corresponding location. When the “cancel” button is selected, another method, class, and app may be selected.

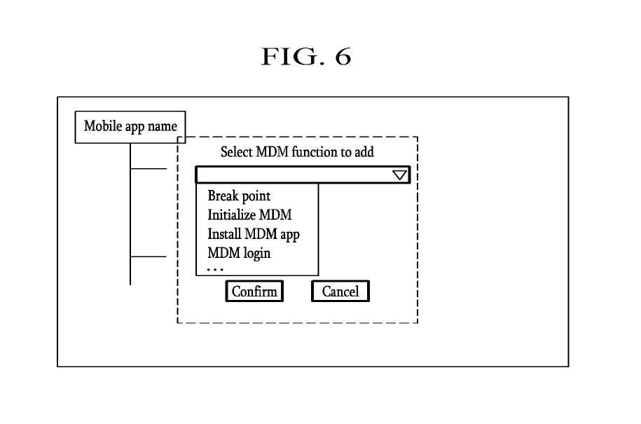

FIG. 6 specifically illustrates a screen in which the MDM function to be added to the class-method of the app may be selected. In a window indicated by the dotted line, a list of MDM functions that may be added in a current location of the mobile app is displayed. When one of the MDM functions is selected and a “confirm” button is selected, an MDM function corresponding to a corresponding location is added as a policy. When the “cancel” button is selected, the window for adding the MDM function is closed, and the screen of FIG. 5 may be outputted.

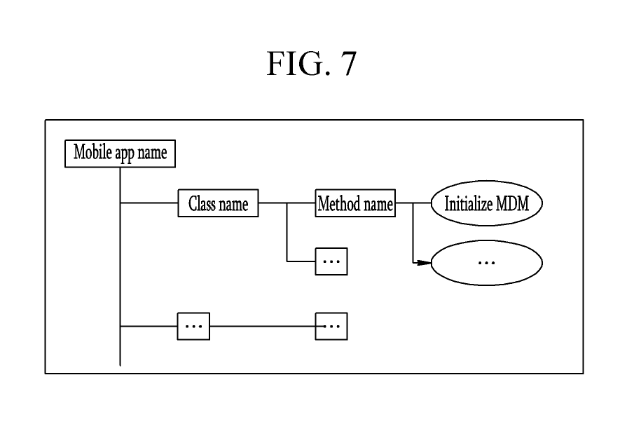

FIG. 7 exemplarily illustrates a screen displayed through the management UI when the “MDM initialization” function is added in FIG. 6.

The MDM function performed in the location with the corresponding class-method name of the mobile app may be queried. At least one MDM function may be added in the same location, and MDM functions may be sequentially performed according to an MDM function sequence. In FIG. 7, when an oval image in which the MDM function is indicated is selected, the administrator may change an execution order of the corresponding function or delete the corresponding function through the management UI. The contents modified by the administrator through the management UI are immediately applied to the MDM policy of the corresponding app to be applied for execution of the corresponding app in real time.

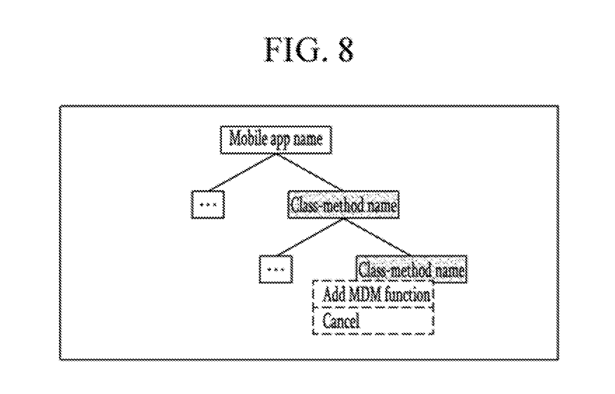

FIG. 8 exemplarily illustrates an operation of adding a policy to perform the MDM function in real time while the modification mobile app according to the exemplary embodiment of the present invention is executed.

The administrator may inquire of an operation flow driven in the mobile app through the management UI as shown in FIG. 8. In a drivable flow of the mobile app, a currently driving flow may be displayed in a different color from those of other boxes. While a specific function of the mobile app is executed in the mobile terminal, execution details of a method of a class corresponding thereto are displayed as shown in FIG. 8, and the currently driving flow of the mobile app, that is, the location being executed, is displayed. In this state, the administrator may add the MDM policy to be applied to a specific location (specific class-method) through the management UI in the screen. It is possible to add MDM policies for a location having been driven by the user, a currently suspended location, and a location to be performed in the future by the user in the mobile app. As shown in the window indicated by the dotted line in FIG. 8, the MDM policy may be set in the same manner as in FIG. 4 to FIG. 7. As such, the administrator may inquire of the call history of the class-method unit of the mobile app executed in the mobile terminal in a graphical form, and specify the MDM function in real time so as to perform an arbitrary MDM function at a specific location.

As described above, in the exemplary embodiment of the present invention, the MDM function supporting the flexible security policy in the binary app may be installed, the MDM interlocking code is inserted at the time of the app modification, and the MDM function is determined and executed according to the MDM policy at the time of driving the modified app. Accordingly, the administrator may modify the binary app without predefining the MDM function in the mobile app. In addition, the MDM function may be specified in real time according to the policy set by the administrator at the time of driving the modified application, thereby solving a redundancy problem of an app wrapping process and a policy setting process.

Further, the MDM function to be applied to the app may be easily queried through the management UI, and may be set in real time at the time of driving it, thereby solving the difficulty of the policy setting process. There is no need to ascertain the configuration and operation to apply it to the mobile app, and the administrator may establish an appropriate policy to apply the MDM function to the arbitrary location without analyzing the detailed configuration and operation of the obfuscated mobile app in advance. Therefore, without the existing tedious and difficult app-wrapping process, the administrator may easily perform the modification and control of the mobile app at any time.

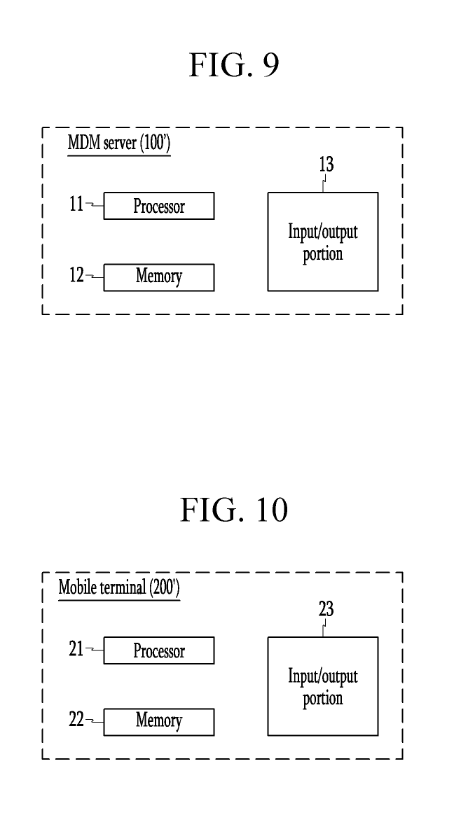

FIG. 9 illustrates a schematic view of an MDM server according to another exemplary embodiment of the present invention.

As shown in FIG. 9, an MDM server 100′ according to another exemplary embodiment of the present invention includes a processor 11, a memory 12, and an input/output portion 13. The processor 11 may be configured to implement the operations and methods described above with reference to FIG. 1 to FIG. 8. For example, the processor 11 may be configured to perform the operations of the app modification processor, the MDM policy processor, and their modules.

The memory 12 is connected to the processor 11, and store various information related to an operation of the processor 11. The memory 12 may store instructions related to operations to be performed by the processor 11, or may temporarily store instructions loaded from a storage device (not shown).

The processor 11 may execute the instructions stored or loaded in the memory 12. The processor 11 and the memory 12 are connected to each other through a bus (not shown), and the bus may be connected to an input and output interface (not shown).

The input/output portion 13 is configured to output a result processed by the processor 11 or to provide data inputted thereto to the processor 11. In addition, the input/output portion 13 is configured to wirelessly transmit and receive a signal to and from the mobile terminal.

FIG. 10 illustrates a schematic view of a mobile terminal according to another exemplary embodiment of the present invention.

As shown in FIG. 10, a mobile terminal 200′ according to an exemplary embodiment of the present invention includes a processor 21, a memory 22, and an input/output portion 23. The processor 21 may be configured to implement the operations and methods described above with reference to FIG. 1 to FIG. 8. For example, the processor 21 may be configured to perform the operations of the MDM processor, the modification mobile app processor, and their modules.

The memory 22 is connected to the processor 21, and stores various information related to operations of the processor 21. The memory 22 may store instructions related to operations to be performed by the processor 21, or may temporarily store instructions loaded from a storage device (not shown).

The processor 21 may execute the instructions stored or loaded in the memory 22. The processor 21 and the memory 22 are connected to each other through a bus (not shown), and the bus may be connected to an input and output interface (not shown).

The input/output portion 23 is configured to output a result processed by the processor 21 or to provide data inputted thereto to the processor 21. In addition, the input/output portion 13 is configured to wirelessly transmit and receive a signal to and from the MDM server.

According to the embodiment of the present invention, it is possible to allow an administrator to set an MDM function of ‘an arbitrary operation’ to ‘an arbitrary location’ for a binary application, whereas in the conventional art, the administrator sets an MDM function of ‘a designated operation’ to ‘a designated location’ therefor.

In addition, when the administrator freely changes an MDM policy to be applied to a mobile application without performing any additional binary modification, it is possible for the mobile application to be executed while applying the changed MDM policy in real time.

Therefore, according to the exemplary embodiment of the present invention, the technical limitation of the existing binary modification scheme can be solved as follows.

First, it is possible to perform the modification of the binary application without predefining the MDM function to be applied to the mobile application. The designating of the MDM function can be performed in real time according to a policy set by the administrator at the time of starting the binary application, not the time of the modification of the binary application.

Second, there is no need to grasp a configuration and an operation thereof for applying the MDM function to the mobile application. Although a detailed configuration and operation of the mobile application protected by obfuscation is not analyzed in advance, the administrator can grasp the operation of the mobile application in a management user interface (UI) in real time and establish a correct policy to apply the MDM function to an arbitrary location.

Third, it is easy to change the MDM function applied to the mobile application. When a policy for applying the MDM function is changed, in the conventional art, the modification of the mobile application is required according to a new policy, but according to the embodiment of the present invention, the MDM function is changed only by changing the policy without modifying the mobile application.

In addition, in order to use an added MDM function in the mobile application, a modification process of including an MDM function for each application is required, but according to the embodiment of the present invention, the added MDM function may be used by merely updating an MDM daemon without modifying each mobile application.

The above-described embodiments can be realized through a program for realizing functions corresponding to the configuration of the embodiments or a recording medium for recording the program in addition to through the above-described device and/or method, which is easily realized by a person skilled in the art.

It will be understood that each block of the accompanying drawings and/or block diagrams, and combinations of blocks in the flowchart illustrations and/or block diagrams, can be implemented by computer program instructions. These computer program instructions may be provided to a processor of a general purpose computer, a special purpose computer, or another programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, another programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, another programmable data processing apparatus, or other devices to cause a series of operational steps to be performed on the computer, the other programmable apparatus, or the other devices to produce a computer implemented process such that the instructions which execute on the computer or the other programmable apparatus provide processes for implementing the functions/acts specified in the flowchart and/or block diagram block or blocks.

Further, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A terminal management method for installing a mobile device management (MDM) function in which a server supports a security policy for a binary mobile application, comprising:
adding, by the server, an MDM interlocking code for each class-method unit of an original application of the binary mobile application;
modifying, by the server, the original application into a modification application; and
generating and transmitting, by the server, an MDM policy including at least one MDM function to be applied to the modification application to a mobile terminal,
wherein the MDM interlocking code checks the MDM policy, and calls an arbitrary MDM function.

2. The terminal management method of claim 1, wherein
the modifying includes:
decompiling the original application to extract class files;
generating a tag with a class name-method name at a beginning portion of a method of each class; and
adding the MDM interlocking code together with the generated tag to the beginning portion of the method.

3. The terminal management method of claim 2, wherein
the modifying includes recompiling the original application to generate the modification application when it is completed to add the tag and the MDM interlocking code for each of the class files of the original application.

4. The terminal management method of claim 1, wherein
the arbitrary MDM function of the MDM policy is performed while the modification application operates in a mobile terminal and the MDM policy is checked according to the MDM interlocking code.

5. The terminal management method of claim 1, further comprising
performing, by the server, policy management of adding, modifying, or deleting the MDM function to, at, or from a predetermined location of each class-method unit of the binary mobile application according to data inputted through a management user interface (UI).

6. The terminal management method of claim 5, wherein
the performing of the policy management includes:
outputting a history of calling the class-method unit including execution details of the method of the class and a currently executing location when the binary mobile application is executed; and
performing policy management of adding, modifying, or deleting the MDM function to, at, or from a predetermined location of the outputted history calling class-method unit.

7. A terminal management method for a mobile terminal that executes a binary mobile application provided from a server, comprising:
executing, by the mobile terminal, the binary mobile application, an MDM interlocking code being added for each class-method unit of the binary mobile application;
checking an MDM policy related to the MDM interlocking code when the MDM interlocking code is identified in the executed binary mobile application; and
performing an arbitrary MDM function of the MDM policy related to the MDM interlocking code.

8. The terminal management method of claim 7, wherein
the MDM interlocking code checks the MDM policy, and calls the arbitrary MDM function.

9. The terminal management method of claim 7, wherein
the checking includes checking the MDM policy related to the MDM interlocking code of the MDM policies when MDM policies including at least one MDM function to be applied to the modification application are provided, stored, and managed from the server.

10. The terminal management method of claim 7, wherein
the MDM policy is represented in a form including an MDM class name, an MDM method name, and a parameter, and
the performing of the MDM function includes calling an MDM class and an MDM method of the MDM policy related to the MDM interlocking code through a JAVA reflection method to perform an MDM function.

11. The terminal management method of claim 10, wherein
the MDM policy includes a tag with a class name-method name, and
the MDM interlocking code is added to a beginning portion of a method of each class together with the tag with the class name-method name.

12. A server provided with an MDM function supporting a security policy for a binary mobile application, comprising:
an input/output portion; and
a processor that is connected to the input/output portion and performs installing of the MDM function,
wherein the processor includes:
an app modification processor configured to add an MDM interlocking code for each class-method unit of an original application of the binary mobile application and to modify the original application into a modification application; and
an MDM policy processor configured to generate an MDM policy including at least one MDM function to be applied to the modification application to transmit it to a mobile terminal through the input/output portion,
wherein the MDM interlocking code checks the MDM policy, and calls the arbitrary MDM function.

13. The server of claim 12, wherein
the app modification processor of the processor includes:
a decompile processing module configured to decompile the original application to extract class files;
an MDM function adding module configured to generate a tag with a class name-method name at a beginning portion of a method of each class and to add the MDM interlocking code together with the generated tag to the beginning portion of the method; and
a recompile processing module configured to recompile the original application to generate the modification application when it is completed to add the tag and the MDM interlocking code for each of the class files of the original application.

14. The server of claim 12, wherein
the input/output portion includes a management UI, and
the MDM policy processor of the processor includes:
a policy management module configured to perform policy management of adding, modifying, or deleting the MDM function to, at, or from a predetermined location of each class-method unit of the binary mobile application according to data inputted through the management UI; and
a policy transmitting module configured to transmit the MDM policy including the MDM function to the mobile terminal through the input/output portion.

15. A mobile terminal that executes a binary mobile application provided from a server, comprising:
an input/output portion; and
a processor that is connected to the input/output portion and executes the binary mobile application,
wherein the processor includes:
an MDM processor configured to receive MDM policies including at least one MDM function to be applied to the modification application through the input/output portion from the server to store and manage it; and
a modification app processor configured to execute the binary mobile application, an MDM interlocking code being added for each class-method unit of the binary mobile application and to load the MDM policy related to the MDM interlocking code from the MDM processor to perform the MDM function,
wherein the MDM interlocking code checks the MDM policy, and calls the arbitrary MDM function.

16. The mobile terminal of claim 15, wherein
the modification app processor of the processor includes:
a code executing module configured to execute the binary mobile application;
a policy checking module configured to check whether the MDM policy related to the MDM interlocking code is present in the MDM processor when the MDM interlocking code is identified in the executed binary mobile application; and
a policy applying module configured to execute the arbitrary MDM function of the MDM policy related to the MDM interlocking code.

17. The mobile terminal of claim 15, wherein
the MDM processor of the processor includes:
a policy database configured to store the MDM policies provided from the server; and
an MDM function processing module configured to perform the MDM function requested by the modification app processor.

18. The mobile terminal of claim 17, wherein
the MDM policy is represented in a form including an MDM class name, an MDM method name, and a parameter, and
the policy applying module is configured to call an MDM class and an MDM method of the MDM policy related to the MDM interlocking code through a JAVA reflection method to perform an MDM function.

19. The mobile terminal of claim 18, wherein
the MDM policy includes a tag with a class name-method name, and
the MDM interlocking code is added to a beginning portion of a method of each class together with the tag with the class name-method name.
